(19) United States
(12) Patent Application Publication
(10) Pub. No.: US 2002/0180184 A1
(43) Pub. Date: Dec. 5, 2002

(54) Foldable pushcart

(76) Inventor: Chung-Hsien Chang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/870,668

(22) Filed: Jun. 1, 2001

(51) Int. Cl. B62B 1/20

(52) U.S. Cl. 280/652; 280/47.27

(57) ABSTRACT

A foldable pushcart has a handle (10), a retractable device (20), and a stretcher (30). The handle (10) is retractable and has a locking case (15) to position the foldable pushcart in a folded state or in an expanded state. The retractable device (20) and stretcher (30) make the movement of the foldable pushcart consistent in one operation.

### BACKGROUND OF THE INVENTION

1. Field of the Invention

The present invention relates to a foldable pushcart, and more particularly to a foldable pushcart expanded and retracted easily.

2. Description of Related Art

A conventional pushcart (60) in accordance with the prior art shown in FIG. 7 comprises a tipping bracket (61), a plate (63) transversally and immovably secured on a bottom portion of the tipping bracket (61), and two wheels (65) rotatably and oppositely configured at joints of the tipping bracket (61) and the plate (63).

Because all elements of the conventional pushcart (60) are fused together by a process such as welding, the conventional pushcart occupies excessive space in storage and not easy to be transported when in a vehicle such as a bus. Therefore, the conventional pushcart is inconvenient.

The present invention has arisen to mitigate and/or obviate the disadvantages of the conventional pushcart.

### SUMMARY OF THE INVENTION

The main objective of the present invention is to provide a foldable pushcart that is expanded and folded flat easily and conveniently.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a foldable pushcart in accordance with the present invention;

FIG. 2 is a cross-sectional view of a locking case of the foldable pushcart in accordance with FIG. 1;

FIG. 3 is an enlarged perspective view of a retractable device of the foldable pushcart when the foldable pushcart is expanded;

FIG. 4 is a cross-sectional side view showing a left side of the retractable device of the foldable pushcart showing that a pallet is retracting;

FIG. 5 is an enlarged perspective view of the retractable device of the foldable pushcart when the foldable pushcart is retracting;

FIG. 6 is a perspective view of the foldable pushcart in accordance with FIG. 1, wherein the foldable pushcart is retracted; and

FIG. 7 is a perspective view of a conventional pushcart.

### DETAILED DESCRIPTION OF THE INVENTION

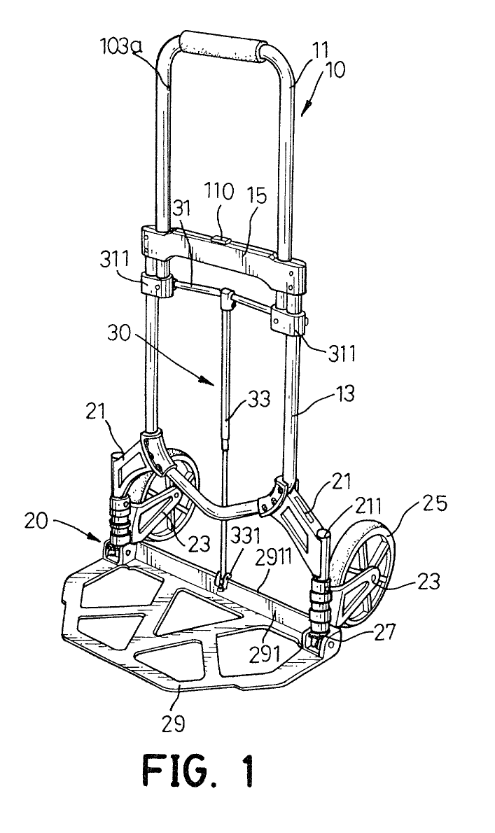

Referring to the drawings and initially to FIG. 1, a foldable pushcart in accordance with the present invention comprises a handle (10), a retractable device (20), and a stretcher (30).

The handle (10) is composed of a first rack (11) shaped as an inverted U, a second rack (13) shaped as a U, and a locking case (15). The first rack (11) and the second rack (13) are combined together with one end of the first rack (11) mated to one end of the second rack (13) by a locking case (15) so that the first rack (11) and the second rack (13) can move in opposite directions to each other. Additionally, the first rack ( 11) has a first pair of lock holes (103a) defined in an upper inner portion of the first rack (11) and a second pair of lock holes (103b) defined in a lower inner portion of the first rack (11).

The locking case (15) slidably secures on the first rack (11) and the second rack (13) and positions the handle (10) when the locking case (15) connects with the lock holes (130a, 130b) of the first rack (11).

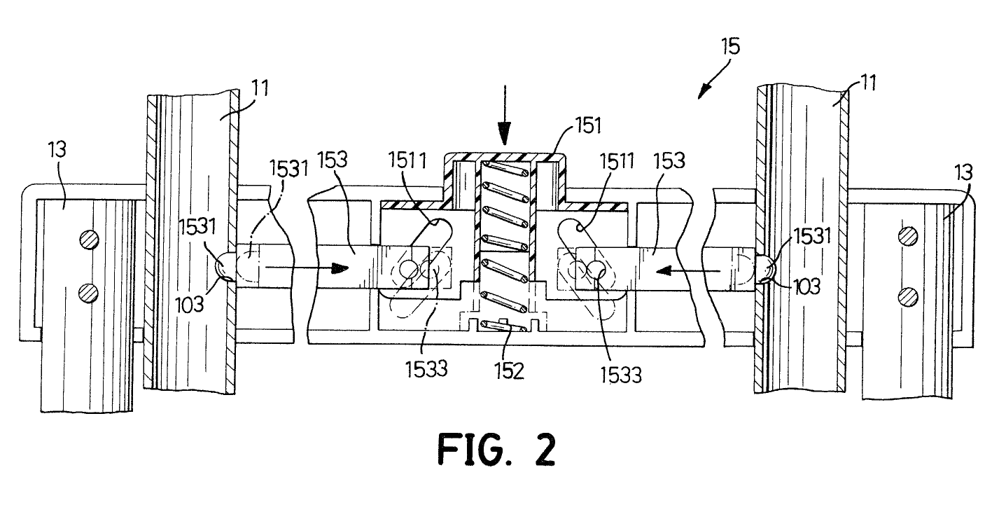

A detailed structure of the locking case is shown in FIG. 2, wherein the locking case (15) has a press button (151) secured in the middle with a head of the press button (151) emerged from the locking case (15) to trigger the movement of the foldable pushcart. A compression spring (152) is sandwiched between the press button (151) and an inner wall of the locking case (15) whereby the press button (151) is urged to a non-actuated mode. The press button (151) has two inwardly inclined apertures (1511) extending close to each other at top ends thereof. Two rods (153) are movably connected with the press button (151). Each rod (153) has a stub (1531) formed at one end to fit in the first pair or second pair of lock holes (103a, 103b) of the first rack (11) and two buds (1533) formed oppositely at the other end of the rod (153). The two buds (1533) are movably rested inside the inclined apertures (1511) so that when the press button (151) is actuated and pressed inward to the center of the locking case (15), the buds (1533) slide upwardly along with the inclined apertures (1511) and then the rods (153) move inwardly. Therefore, the stubs (1531) are drawn back and released from the first or second pair of lock holes (103a/103b) so that the first rack (11) and the second rack (13) are enabled to move oppositely.

With reference to FIGS. 1, 3 and 4, the retractable device (20) has a pair of braces (21), a pair of wheel racks (23), two wheels (25), two gear assemblies (27), and a pallet (29).

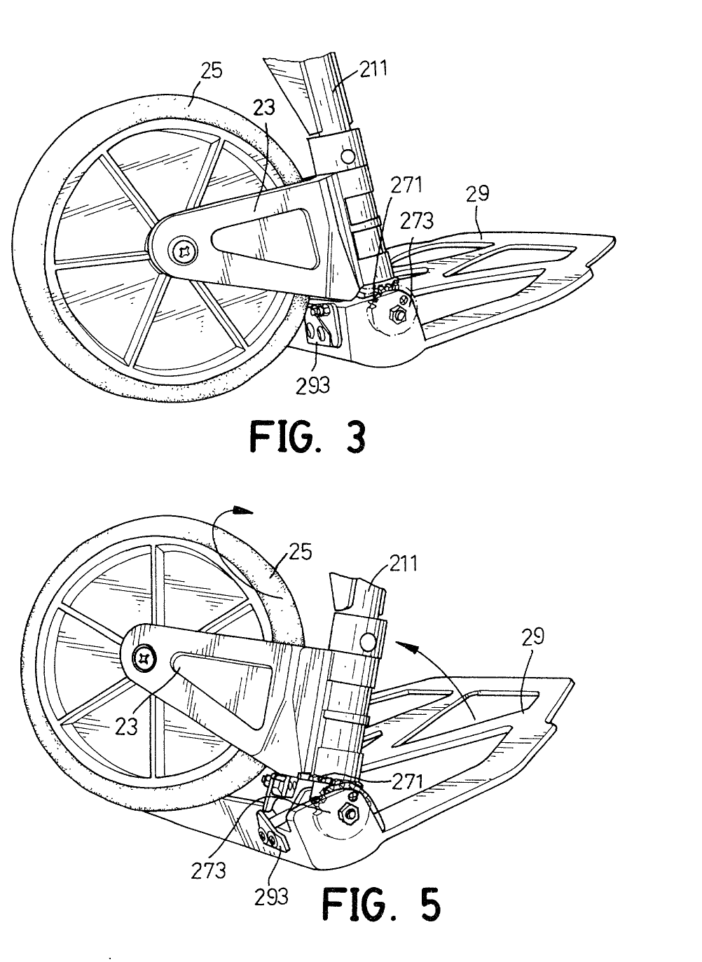

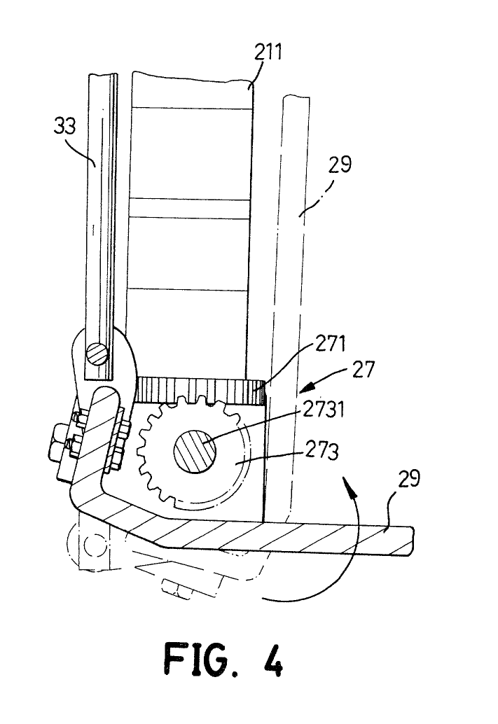

Each brace (21) has one end firmly jointed on the second rack (13) and the other end movably connected with the wheel rack (23) by a supporting rod (211). The wheel rack (23) is sleeved on the supporting rod (211) and extends backwardly to secure a respective one of the wheels (25) on the wheel rack (23). Each gear assembly (27) is composed of a first gear (271) immobile attached with the respective wheel rack (23) and a second gear (273) vertically and derivably fitted with the first gear (271). The second gear (273) has an axle (2731) firmly combined with the pallet (29) so as to be driven when the pallet (29) moves pivotally and vertically (as shown in FIG. 4). Referring back to FIG. 1, the pallet (29) has a back plate (291) and an inclined face (2911) formed on a top edge of the back plate (291). Additionally, a pair of locking sheets (293) (in FIG. 3) is attached on a back face of the back plate (291) to enhance the positioning effect of the retractable device (20) by jigsawing and interlocking the sheets (293) together when the foldable pushcart is expanded.

Referring to FIG. 1, the stretcher (30) is a T-shaped structure that is composed of a horizontal stick (31) and a retractable vertical stick (33). Each end of the horizontal stick (31) has a connector (311) to firmly secure therewith distal ends of the first rack (11) of the handle (10). The connectors (311) slidably sleeve on the second rack (13). The vertical stick (33) has one end secured on a middle portion of the horizontal stick (31) and a free end pivotably mounted on the inclined face (2911) of the pallet (29). Two push leaves (331) are secured at opposite sides of the free end of the vertical stick (33) to promote the pallet (29) to move outwardly when the foldable pushcart is expanded.

Now referring to FIGS. 1, 3, 4 and 5, retracting movement of the foldable pushcart starts when the press button (151) is pushed and the first rack (11) is pressed downwardly, so that the handle (10) moves closer to the stretcher (30), and the free end of the vertical stick (33) presses the inclined face (2911) of the pallet (29). The vertical stick (33) forces and presses the pallet (29) at the inclined face (2911) and then slides downwardly along the inclined face (2911) to smoothly prize the pallet (29). Therefore, as shown in FIGS. 4 and 5, the pallet (29) levers up and the second gears (273) are rotated. Then the first gears (271) are respectively rotated by the second gears (273) to drive the wheel racks (23) to retract inwardly and thus swing towards each other.

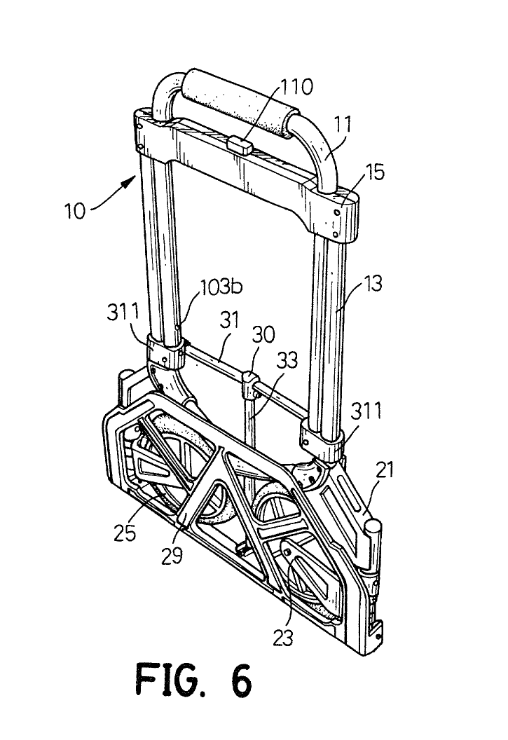

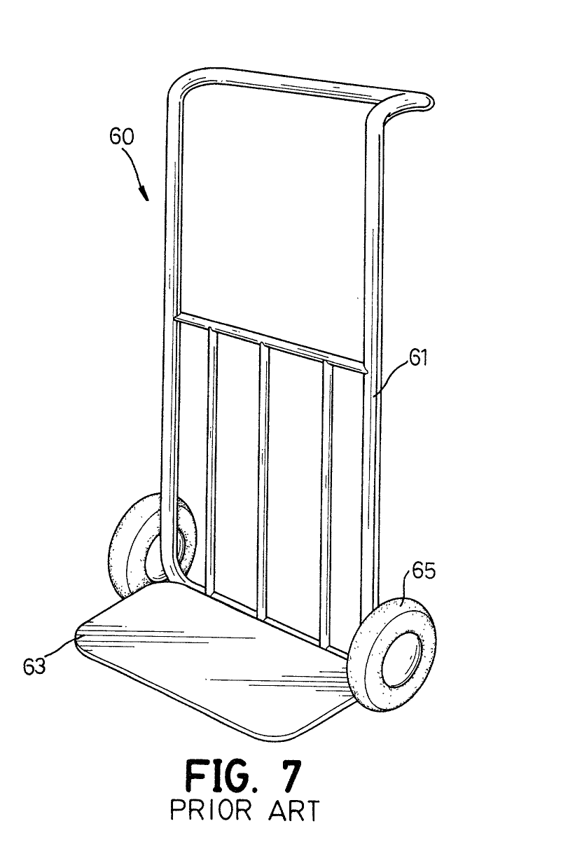

The foldable pushcart shown in FIG. 6 is completely retracted, at that time, the locking case (15) is firmly secured to the first pair of lock holes (103a) of the first rack (11) and the whole foldable pushcart is secured in this condition. Therefore, the foldable pushcart is compact in storage and easily portable when not containing items.

When the foldable pushcart is to be expanded, the press button (151) is pushed again to release the locking case (15) and the first rack (11) is pulled up away from the locking case (15) so that the handle (10) and the stretcher (30) are extending. When the vertical stick (33) of the stretcher (30) extends to the limit, the push leaves (331) of the vertical stick (33) push the pallet (29) outwardly. Then the second gears (273) are driven again but in a reverse direction to make the first gears (271) rotate, and the wheel racks (23) with wheels (25) are promoted outwardly to extended positions as shown in FIG. 1. Meanwhile, the locking case (15) is firmly secured on the second pair of lock holes (103b) to position the handle (10) and the set of locking sheets (293) is assembled together to enhance the positioning effect of the retractable device (20).

Although the invention has been explained in relation to its preferred embodiment, but it is illustrated only and easy to be understood that many other possible modifications and variations can be made without departing from the spirit and scope of the invention as hereinafter claimed.

What is claimed is:

1. A foldable pushcart comprising:
a handle (10) having
a first rack (11) having multiple lock holes (103);
a second rack (13) retractably combined with the first rack (11); and
a locking case (15) slidably secured on the first rack (11) and firmly mounted on the second rack (13) to position the handle (10);
a retractable device (20) having
two pairs of braces (21), each brace (21) firmly jointed on the second rack (13) of the handle (10) to support the handle (10);
two pairs of wheel racks (23), each wheel rack (23) pivotally connected with the brace (21) and adapted to be transversally moved;
two gear assemblies (27), each gear assembly secured between the brace (21) and the wheel rack (23) to drive the wheel rack (23); and
a pallet (29) movably secured under the gear assembly to be retracted inwardly to the braces (21).

2. The foldable pushcart as claimed in claim 1 further comprising a stretcher (30) secured between the handle (10) and the pallet (29) of the retractable device (20), the stretcher (30) having
a horizontal stick (31) transversally secured on the second rack (13);
a vertical stick (33) having one end firmly secured on the horizontal stick (31) and another end pivotally mounted on the pallet (29) to promote the movement of the pallet (29);
wherein when the handle (10) is retracted or expanded, the stretcher (30) triggers the retractable device (20) to actuate at the same time.

3. The foldable pushcart as claimed in claim 1, wherein the locking case (15) has
a press button (151) resiliently secured by an elastic member on the locking case (15) and having two symmetrical inclined apertures (1511) respectively defined in two side walls of the press button (151);
two rods (153) movably connected with the press button (151), each rod (153) having
a stub (1531) formed at one end of the rod (153) and adapted to fit in the lock holes (103) of the first rack (11); and
two buds (1533) formed respectively and oppositely on the rods (153) and movably rested in the inclined apertures (1511) of the press button so that when the press button (151) is actuated, the buds (1533) slide upwardly along the inclined apertures (1511) and then the rods (153) move inwardly, whereby the stubs (1531) are withdrawn from a first pair of the multiple lock holes (103) of the first rack (11), and when the press button is released, the elastic member urges the press button back to a non-actuated mode whereby the buds (1533) slide downwardly along the inclined apertures (1511) and the rods (153) enter a second pair of the multiple lock holes (103) of the first rack (11).

4. The foldable pushcart as claimed in claim 1, wherein the pallet (29) has a back plate (291), an inclined face (2911) formed on a top edge of the back plate (291) to make the pallet (29) to be triggered easily when the vertical stick (33) of the stretcher (30) presses and jostles against the back plate (291), the vertical stick (33) slides along the inclined face (2911) to smoothly prize the pallet (29).

5. The foldable pushcart as claimed in claim 2, wherein the pallet (29) has a back plate (291), an inclined face (2911) formed on a top edge of the back plate (291) to make the pallet (29) to be triggered easily when the vertical stick (33) of the stretcher (30) presses and jostles against the back plate (291), the vertical stick (33) slides along the inclined face (2911) to smoothly prize the pallet(29).

6. The foldable pushcart as claimed in claim 3, wherein the pallet (29) has a back plate (291), an inclined face (2911) formed on a top edge of the back plate (291) to make the pallet (29) to be triggered easily when the vertical stick (33) of the stretcher (30) presses and jostles against the back plate (291), the vertical stick (33) slides along the inclined face (2911) to smoothly prize the pallet (29).

7. The foldable pushcart as claimed in claim 4, wherein a pair of locking sheets (293) are attached on a back face of the back plate (291) to enhance the positioning effect of the retractable device (20) when the foldable pushcart is expanded.

8. The foldable pushcart as claimed in claim 5, wherein a pair of locking sheet (293) are attached on a back face of the back plate (291) to enhance the positioning effect of the retractable device (20) when the foldable pushcart is expanded.

9. The foldable pushcart as claimed in claim 6, wherein a pair of locking sheets (293) are attached on a back face of the back plate (291) to enhance the positioning effect of the retractable device (20) when the foldable pushcart is expanded.

10. The foldable pushcart as claimed in claim 2, wherein the horizontal stick (31) has two connectors (311) firmly secured on distal ends thereof and the connectors (311) are firmly secured to the first rack (11) of the handle (10) and slidably sleeved on the second rack (13).

11. The foldable pushcart as claimed in claim 5, wherein the horizontal stick (31) has two connectors (311) firmly secured on distal ends thereof and the connectors (311) are firmly secured to the first rack (11) of the handle (10) and slidably sleeved on the second rack (13).

12. The foldable pushcart as claimed in claim 8, wherein the horizontal stick (31) has two connectors (311) firmly secured on distal ends thereof and the connectors (311) are firmly secured to the first rack (11) of the handle (10) and slidably sleeved on the second rack (13).
